(19) United States
(12) Patent Application Publication
(10) Pub. No.: US 2007/0177487 A1
(43) Pub. Date: Aug. 2, 2007

(54) Optical disc apparatus and optical disc

(76) Inventors: Naohito Ikeda, Yokohama (JP); Tatsuya Ishitobi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/492,930

(22) Filed: Jul. 26, 2006

(30) Foreign Application Priority Data
Oct. 12, 2005 (JP) 2005-297083

(51) Int. Cl. G11B 7/00

(52) U.S. Cl. 369/116

(57) ABSTRACT

In a user data area, control of recording laser power cannot be performed accurately. In recording data in the user data area, data for the control of recording laser power is also recorded together with user data to be recorded. By reproducing the data for control of recording laser power, the recording laser power can be controlled to be suitable for a user data recording position and user data is recorded with use of the thus-controlled laser power. In this way the recording laser power can be controlled to be suitable for a recording position on an optical disc and hence an optical disc superior in recording quality is realized.

### CLAIM OF PRIORITY

The present application claims priority from Japanese application serial No. P2005-297083, filed on Oct. 12, 2005, the content of which is hereby incorporated by reference into this application.

### BACKGROUND OF THE INVENTION

1. Field of the Invention

The present invention relates to an optical disc apparatus and particularly to controlling recording laser power for an optical disc.

2. Description of the Related Art

To record data onto a recording type optical disc, laser light is radiated to a recording surface of the optical disc to apply heat to the recording surface. As a result, a recording mark is formed on the recording surface of the optical disc and is recorded as data. At this time, the laser power for recording data onto the disc is controlled and determined by recording data on trial and then reproducing (here, this “reproducing” signifies irradiating laser light onto the disc and acquiring the signal of reflected light from the region of the disc on which laser light is irradiated) the data in a power control area which is provided logically in the optical disc standard.

The control of the recording laser power will hereinafter be referred to as OPC (Optimum Power Control). According to the conventional optical disc standard, the area for OPC is present in the inner or outer periphery of the disc. The area for OPC will hereinafter be referred to as PCA (Power Calibration Area). By performing OPC in PCA, it is possible to control the recording laser power into a power suitable for the disc.

The recording laser power optimum for the disc also varies due to a difference in sensitivity characteristic of the optical disc between the inner periphery and the outer periphery or a change in ambient temperature. Therefore, the recording power determined in PCA is not always an optimal laser power. To solve this problem, in Japanese Patent Laid-Open No. 2000-182245, reading of recorded information is performed intermittently in a short unit, the power of laser light in information recording and the jitter of a reproduced signal obtained in the above intermittent reproduction are measured at every information recording, such a recording laser power as gives a minimum jitter quantity is determined, and the laser light power of the thus-determined value is set at every information recording.

### SUMMARY OF THE INVENTION

Japanese Patent Laid-Open No. 2000-182245 discloses a method wherein recorded data is reproduced to obtain a relation between recording power and the jitter of a reproduced signal and the recording power is controlled on the basis of the relation thus obtained. Therefore, it is only the relation between the power used in actual data recording and a reproduced jitter resulting from reproduction of the data recorded with the power that can be grasped. That is, the value calculated in the above laser power control is a value calculated on the basis of the laser power already recorded. There is no information on laser power in an area to be recorded in future or an unrecorded area. For calculation and control of a recording laser power suitable for recording, a difficulty is encountered in point of accuracy. There also has been the problem that it is difficult to control the laser power with only the relation between the laser power and the reproduced jitter.

This is for the following reason. The reproduced jitter is considered to be one index value for ascertaining the recording quality. However, worsening of the reproduced jitter does not lead to judgment whether an appropriate recording laser power is too high or too low. Particularly, when the number of times of sampling is small with respect to the relation between recording laser power and reproduced jitter, a shift may be made in a direction opposite to an appropriate power direction by mistake when controlling the recording laser power. Further, even if a laser power controlling direction is known, it is difficult to determine to what degree the power is to be changed.

Taking into account of the power control accuracy as the aforesaid subject, the present invention resides in an optical disc apparatus able to control laser power in higher accuracy, as well as an optical disc.

The aforesaid subject is achieved by the invention described in the appended claims.

More specifically, when recording user data in a user data area, data for control of recording laser power is also added for recording to user data to be recorded. Then, by reproducing the thus-added data for control of recording laser power, it is possible to control a recording laser power suitable for a recording position, at which recording laser power suitable for the user data recording area is obtained.

According to the present invention it is possible to control a recording laser power suitable for a recording position of an optical disc to enhance the recording quality.

### BRIEF DESCRIPTION OF THE DRAWINGS

FIG. 1 illustrates a data recording method in a user data area according to the present invention;

FIG. 2 illustrates an application of the data recording method in the user data area according to the present invention;

FIG. 3 is a construction diagram of a conventional optical disc; and

FIG. 4 illustrates a conventional OPC method.

### DESCRIPTION OF THE PREFERRED EMBODIMENTS

In carrying out the present invention, it is not necessary to add any special function to a conventional optical disc apparatus.

First, before describing the contents of the present invention, a description will be given below about a conventional optical disc apparatus and the conventional OPC.

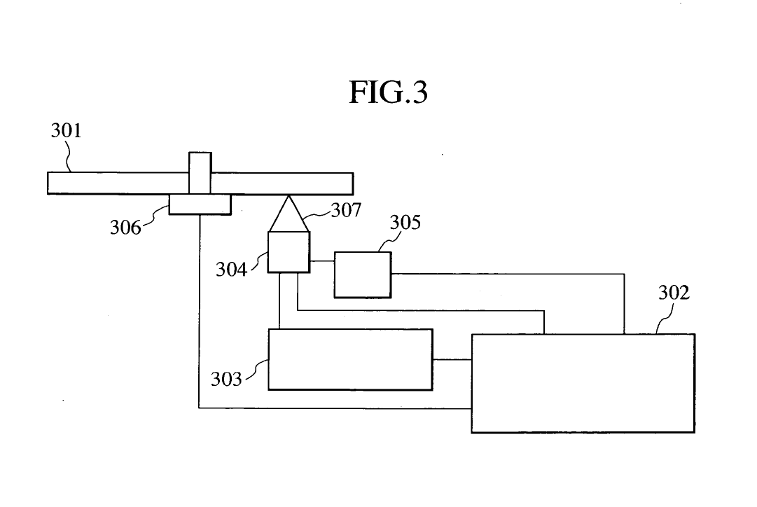

The following description is now provided about a conventional optical disc apparatus with reference to FIG. 3 which shows as an example a series of operations until the optical disc apparatus records data onto a disc.

In order for the optical disc apparatus to record data onto an optical disc 301, first a drive control system 302 controls a spindle mechanism 306 to rotate the optical disc 301. Then, the drive control system 302 designates arbitrary data to be recorded, recording laser power to be radiated by the optical pick-up 304, and the position for recording data onto the disc 301.

A laser controller 303 makes control so that laser light 307 is radiated from the optical pick-up 304 with the laser power designated by the drive control system 302. An optical pick-up drive mechanism 305 controls the optical pick-up 304 so that recording can be performed at the data recording position over the optical disc 301 designated by the drive control system 302, and moves the optical pick-up 304 to a desired position. Thereafter, with recording power from the optical pick-up 304, the laser light 307 is radiated to the disc 301 to record data. These are a series of operations in recording.

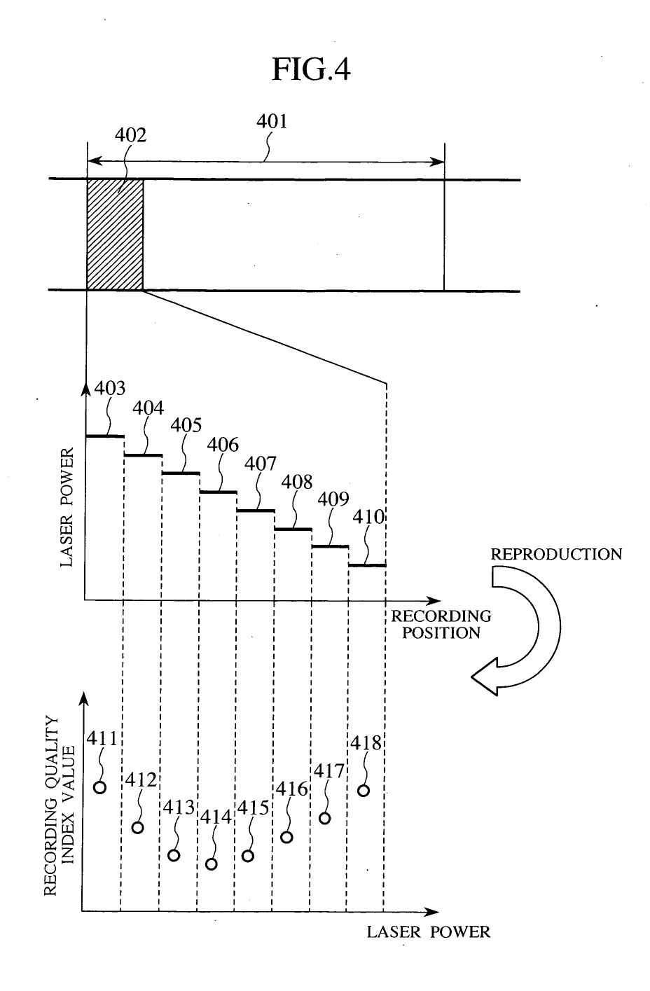

The conventional OPC will now be described with reference to FIGS. 3 and 4. FIG. 4 illustrates a conventional OPC method using a PCA on the disc 301. First, the optical pick-up 304 is positioned to the PCA 401 on the disc 301 and laser power is varied in a region 402 within the PCA 401 to record data. For example, the recording of data is performed while changing the value of laser power like 403, 404, 405, 406, 407, 408, 409, and 410.

Next, reproduction is performed for the region 402. The optical pick-up 304 is positioned to the region 402 and the drive control system 302 instructs the laser controller 303 to emit laser power for reproduction lower than the recording power. The laser power for reproduction is emitted from the optical pick-up 304 and reflected light from the region 402 is acquired through the optical pick-up 304 to reproduce data of the region 402.

At this time, a recording quality index value is acquired from the reproduced signal, whereby the recording quality of the reproduced portion can be evaluated. In this case, since recording of data is performed while changing the laser power like 403, 404, 405, 406, 407, 408, 409, and 410, it is possible, by reproducing each of recorded regions using such various laser powers, to obtain recording quality index values 411, 412, 413, 414, 415, 416, 417, and 418 for the various laser powers respectively. Consequently, it is possible to calculate the relation between laser power and recording quality index value in high accuracy.

On the basis of this relation, it is possible to control the laser power in recording. The above is the conventional OPC. This example is a mere example and the number of times of changing of laser power and the distribution of index values are not limited to those described above.

A description will now be given of the recording laser power control according to the present invention. The recording laser power control according to the present invention is characteristic in that, when recording data to the user data area, data for use in recording laser power control is also recorded at the same time. This data is similar to the data recorded in the conventional OPC and therefore will hereinafter be referred to as OPC data. The numeral 102 denotes user data to be actually recorded in the user data area on the disc 301. The numeral 101 denotes OPC data.

When recording user data 102 in a user data area 103, OPC data 101 is also recorded in synchronism therewith. Consequently, when data is recorded in the user data area 103, the OPC data 101 is also recorded in the same area. Thus, when the recording of user data 102 is repeated, OPC data 101 will be present in the user data area 103.

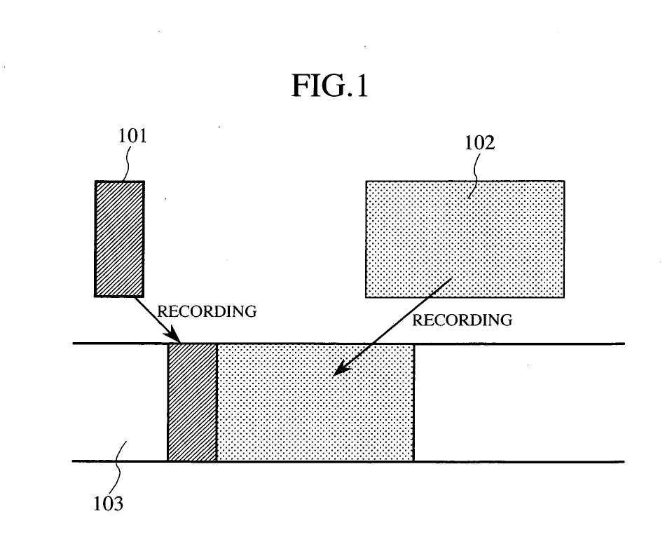

In the present invention, OPC data 101 closest to a next-time disc recording position is reproduced and the recording laser power is controlled on the basis of the reproduced data. In FIG. 1, the OPC data 101 and the user data 102 are adjacent to each other, but this is a mere example and it is not always necessary for both data to be adjacent to each other. The order of OPC data 101 and that of user data 102 may be replaced with each other.

Data convenient for the calculation of recording laser power may be recorded for the OPC data 101, like the conventional OPC shown in FIG. 4. If recording is made while changing the recording laser power as in FIG. 4, such data as is recorded in PCA in conventionally is recorded in the user data area and, by reproducing the data, it is possible to realize a recording laser power control equal to the conventional OPC.

As a result, the accuracy problem in the recording laser power control in the user data area in the conventional method can be solved.

Since the conventional OPC is sure to utilize PCA, it has been necessary to move an optical pick-up 104 up to PCA provided in the inner or outer periphery of a disc whenever OPC is executed. Therefore, when it is necessary to control the recording laser power due to a change of the ambient temperature, some inconveniences are caused by movement of the optical pick-up 104 to PCA. One inconvenience is that the movement time of the optical pick-up 104 affects the data recording time to deteriorate the recording performance of the optical disc drive.

Moreover, with movement of the optical pick-up 104, the optical disc drive may be given unnecessary vibration and noise. For example, when the optical disc drive is applied to a camera or the like, such a serious problem for the user has been arisen that a noise may be taken into the camera or shaking of hands due to vibration may be occurred. This is a serious problem for the user.

In the present invention such a power control as OPC can be realized in the vicinity of a next-time data recording position within the user data area during recording, so that the movement of the optical pick-up 104 is diminished and it is possible to solve the above-mentioned problem.

Further, in the conventional OPC, when the sensitivity characteristic is different between the inside and the outside of the disc or when there is stain such as a fingerprint in the recording position, the recording laser power controlled in PCA may not be optimal. In the present invention, however, since it is possible to control the laser power just near the user data recording position, the recording laser power can be controlled to suitable one according to the disc position and hence it is possible to ensure a good recording quality at all times.

The following description is now provided about a method for making the present invention more effective.

Usually, in recording user data 102 onto the optical disc 301, a minimum unit comprising the user data 102 with an error correcting code added thereto is a minimum unit. The minimum recording unit in recording the user data 102 will hereinafter be referred to as a user data block.

The present invention can be made more effective by recording the OPC data 101 in synchronism with the user data block. As a result, in an already recorded portion, the OPC data 101 are dotted about the whole of the optical disc 301, whereby the accuracy of the recording laser power control is greatly improved.

Although the user data block is considered to be the user data 102 as an application of the present invention in the above example, since this example is a mere example, it is not always necessary for the user data 102 to be the user data block unit.

In applying the present invention, if the OPC data 101 is recorded in synchronism with the user data block, since the user data area of the optical disc 301 is finite, the larger to excess the occupancy area of the OPC data 101, the narrower the recordable area of the user data 102. In view of this point, the present invention permits the use of the OPC data 101 in the following manner.

Usually, in case of making OPC, recording is performed in PCA while changing the laser power as is illustrated in FIG. 4. In the present invention, when the OPC data 101 is recorded in synchronism with the user data block, if it is desired to write much user data 102 into the user data area, it is necessary to reduce the area for the OPC data 101. In the case where the area for the OPC data 101 is made small, recording while greatly changing the laser power, as in FIG. 4, becomes difficult.

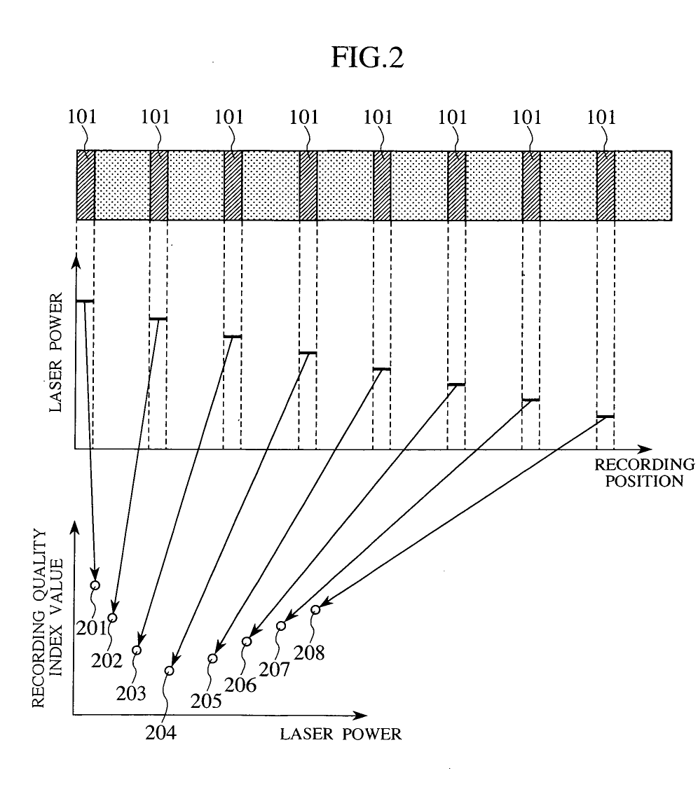

This problem can be solved by changing the way of recording the OPC data 101 as shown in FIG. 2. FIG. 2 shows an example according to the present invention, in which a user data block as a single recording unit comprising OPC data 101 and user data 102 is recorded eight times repeatedly. The user data block is recorded eight times inevitably means that the OPC data 101 is recorded eight times in synchronism therewith. In this case, when recording OPC data 101 for one time, the recording is performed without changing the laser power. As shown in FIG. 2, the laser powers for recording the OPC data 101 are made different eight ones, and to determine such recording laser powers, OPC data 101 at eight positions are reproduced. Although the recording laser powers for the OPC data 101 are made different eight ones in this example, it is sufficient for laser powers to be at least two different values.

Thus, it is possible to control the laser power even in the case where it is impossible to ensure a large area for the OPC data 101. As this example is a mere example, it is not always necessary that the number of times of changing the laser power be eight. Furthermore, it is not always necessary that a single OPC data 101 be data recorded with a single power. Of course, each OPC data 101 may be recorded using plural types of laser powers and the control of the recording laser power may be made from plural OPC data 101.

To make the above method more effective it is preferable that the conventional OPC be conducted before recording the user data 102 onto the optical disc 301. Even if the optical disc 301 is of the type which varies in sensitivity characteristic depending on the disc position, it is rarely the case that the recording power calculated in OPC and suitable for the disc position are required to be markedly different from each other.

Therefore, the number of times of changing the laser power for the OPC data 101 can be decreased by executing OPC beforehand to calculate the recording laser power. For example, with reference FIG. 2, it is not necessary to widely change the laser power from 201 to 208 but with use of the laser powers of 202 to 206 which are close to an optimum recording power, recording and reproducing OPC data 101 are performed. This makes it possible to calculate the recording power 204 to be an optimum recording power.

According to this method it is possible to utilize the OPC data effectively and the recording laser power can be controlled in higher accuracy throughout the entire disc.

Although reference has been made above to the laser power controlling method according to the present invention which uses OPC data 101 and which is close to the conventional OPC method, it is not always necessary to make the power control in the same way as in the conventional OPC method. The OPC data 101 may be used in a different way of use as data for controlling the laser power.

What is claimed is:

1. An optical disc apparatus comprising:
a recording device, said recording device recording a plurality of recording data blocks repeatedly in a user data recordable area which permits a user of a recordable optical disc to record user data therein, each of said recording data blocks comprising a user data area for recording user data and an area for recording data to control recording laser power,
wherein the data to control recording laser power in the repeatedly-recorded recording data blocks are recorded using at least two different values.

2. The optical disc apparatus according to claim 1, wherein recording laser power to be used in next-time user data recording is controlled on the basis of the data to control the recording laser power in the repeatedly-recorded recording data blocks.

3. The optical disc apparatus according to claim 1, wherein the user data area for recording user data and the area for recording data to control recording laser power correspond to a minimum unit of data with an error correcting code added thereto.

4. A recordable optical disc comprising a user data recordable area permitting a user to record data therein, said user data recordable area permitting a plurality of recording data blocks to be recorded therein repeatedly, each of said recording data blocks comprising a user data area for recording user data and an area for recording data to control recording laser power,
wherein the data to control recording laser power in the repeatedly-recorded recording data blocks are recorded using at least two different values.

5. The optical disc according to claim 4, wherein the data to control the recording laser power, when reproduced after recording, permits an optical disc apparatus to control laser power suitable for a disc position at which the user data is recorded.

6. The optical disc according to claim 5, wherein in said user data recordable area, data of a minimum recording data unit with an error correction code added thereto is recorded in each of the user data area and the area for recording data to control recording laser power.

7. The optical disc according to claim 6, wherein the user data area and the area for recording data to control recording laser power are arranged in a regularly repeated manner.
